(19) United States
(12) Patent Application Publication
(10) Pub. No.: US 2025/0034798 A1
(43) Pub. Date: Jan. 30, 2025

(54) MODIFIED CARBON FIBER, CARBON FIBER REINFORCED PLASTICS, AND METHOD FOR PRODUCING THE MODIFIED CARBON FIBER

(71) Applicants: NISSAN MOTOR CO., LTD., Yokohama-shi (JP); TOKYO INSTITUTE OF TECHNOLOGY, Tokyo (JP)

(72) Inventors: Asuka SAKAI, Atsugi-shi (JP); Masatoshi KUBOUCHI, Meguro-ku (JP); Winarto KURNIAWAN, Meguro-ku (JP)

(73) Assignees: NISSAN MOTOR CO., LTD., Yokohama-shi (JP); TOKYO INSTITUTE OF TECHNOLOGY, Tokyo (JP)

(21) Appl. No.: 18/784,482

(22) Filed: Jul. 25, 2024

(30) Foreign Application Priority Data
Jul. 26, 2023 (JP) 2023-121691

(51) Int. Cl. D06M 13/322; C08K 9/04; D06M 13/10; D06M 101/40

(52) U.S. Cl. CPC D06M 13/322; C08K 9/04; D06M 13/10; D06M 2101/40

(57) ABSTRACT

A modified carbon fiber includes carbon atoms in which a proportion of carbon atoms to which a functional group containing at least one of an oxygen atom and a nitrogen atom is bonded are 55.5 atomic % or more and 68.0 atomic % or less, when a total of carbon atoms present on a surface of the carbon fiber and a surface of an internal void inside the carbon fiber is 100 atomic %.

### TECHNICAL FIELD

The present invention relates to a modified carbon fiber, carbon fiber reinforced plastics, and a method for producing the modified carbon fiber, and more particularly, to a modified carbon fiber having excellent fiber strength and excellent adhesion to resin, a carbon fiber reinforced plastics including the modified carbon fiber, and a method for producing the modified carbon fiber.

### BACKGROUND ART

Patent Document 1 discloses a method for treating surfaces of carbon fibers that efficiently perform the followings simultaneously: to increase anchoring effect by increasing uneven surfaces, which are effective for improving adhesion with matrix resin, on the carbon fiber surfaces; and to mainly introduce oxygen-containing functional groups by removing unnecessary components while leaving only oxygen-containing functional groups. This method for treating surfaces of carbon fibers is a method to treat surfaces of carbon fibers by electrolytic oxidation. In particular, (a) the fibers are subjected to an electrolytic oxidation treatment under severe conditions, that is, the carbon fibers are used as an anode and electrical quantity of 50 c/g or more is passed through the electrolyte, and (b) next, the fibers, after washed in water and dried, are performed heat treatment in an oxygen-containing atmosphere.

Patent Document 2 discloses a method for recovering carbon fibers that allows carbon fibers to be easily recovered from carbon fiber composite materials using completely new means that has never existed before. This method for recovering carbon fibers includes: anodizing carbon fiber composite materials; and decomposing at least a portion of the carbon fiber composite materials into fibrous form.

### CITATION LIST

### Patent Literatures

[Patent Literature 1] JP P H05-044155 A
[Patent Literature 2] JP P 2013-249386 A

### SUMMARY OF INVENTION

### Technical Problem

Nevertheless, in the method for treating surfaces of carbon fibers as described in Patent Document 1, it is required for heat-treating carbon fibers at around 200 to 300 degrees C. in an oxygen-containing atmosphere, which may cause damage to the carbon fibers. In the method for recovering carbon fibers as described in Patent Document 2, when the carbon fiber composite material is carbon fiber reinforced plastics, it is required for heat-treating the carbon fiber reinforced plastics in an oxygen-containing atmosphere prior to anodizing, which may cause damage to the carbon fibers.

The present invention has been made in view of the problems of the prior arts, and the object of the present invention is to provide a modified carbon fiber having excellent fiber strength and excellent adhesion to resin, a carbon fiber reinforced plastics including the modified carbon fiber, and a method for producing the modified carbon fiber.

### Solution to Problem

The inventors of the present invention have extensively studied to achieve the above object. Then, they have found that the above object can be achieved by a carbon fiber having a configuration in which the proportion of carbon atoms to which a predetermined functional group is bonded is within a predetermined range, when the total of carbon atoms present on the surface of the carbon fiber and the surface of an internal void inside the carbon fiber is taken as 100 atomic %. Thus, the present invention has been completed.

That is, a modified carbon fiber of the present invention has the proportion of carbon atoms to which a functional group containing at least one of an oxygen atom and a nitrogen atom is bonded is 55.5 atomic % or more and 68.0 atomic % or less, when the total of carbon atoms present on the surface of the carbon fiber and the surface of the internal void inside the carbon fiber is 100 atomic %.

Moreover, a carbon fiber reinforced plastics of the present invention is a carbon fiber reinforced plastics produced by reinforcing resin with the modified carbon fiber.

The modified carbon fiber has the proportion of carbon atoms to which a functional group containing at least one of an oxygen atom and a nitrogen atom is bonded is 55.5 atomic % or more and 68.0 atomic % or less, when the total of carbon atoms present on the surface of the carbon fiber and the surface of the internal void inside the carbon fiber is taken as 100 atomic %.

Furthermore, in a method for producing a modified carbon fiber of the present invention, a modified carbon fiber is produced that has the proportion of carbon atoms to which a functional group containing at least one of an oxygen atom and a nitrogen atom is bonded is 55.5 atomic % or more and 68.0 atomic % or less, when the total of carbon atoms present on the surface of the carbon fiber and the surface of the internal void inside the carbon fiber is taken as 100 atomic %.

The method for producing a modified carbon fiber of the present invention includes the following steps: when producing a modified carbon fiber, carbon fiber reinforced plastics containing a carbon fiber and resin or a carbon fiber is immersed in a nitric acid aqueous solution at a temperature of 60 degree C. or more and 80 degree C. or less and a concentration of 4 mol/L or more and 8 mol/L or less, for 8 hours or more.

### Advantageous Effects of Invention

According to the present invention, since the proportion of carbon atoms to which the above-mentioned functional groups are bonded is within the above-mentioned range, when the total of carbon atoms present on the surface of the carbon fiber and the surface of the internal void inside the carbon fiber is taken as 100 atomic %, a modified carbon fiber having excellent fiber strength and excellent adhesion to resin, carbon fiber reinforced plastics including the modified carbon fiber, and a method for producing a carbon fiber can be provided.

### BRIEF DESCRIPTION OF DRAWINGS

FIG. 1 is an explanatory diagram showing a method for recovering recycled carbon fibers from automotive carbon fiber reinforced plastics parts by a nitric acid decomposition method.

FIG. 2 shows a scanning electron microscope image and a photograph of virgin carbon fiber (Test Example 1), and a scanning electron microscope image and photograph of carbon fiber recovered after being immersed the virgin carbon fiber in a nitric acid aqueous solution for 8 hours (Test Example 2).

FIG. 3 shows a scanning electron microscope image and photograph of recycled carbon fiber recovered after being immersed an automotive carbon fiber reinforced plastics sample in a nitric acid aqueous solution for 8 hours (Test Example 3), and a scanning electron microscope image and photograph of recycled carbon fiber recovered after an automotive carbon fiber reinforced plastics sample is immersed in a nitric acid aqueous solution for 12 hours (Test Example 4).

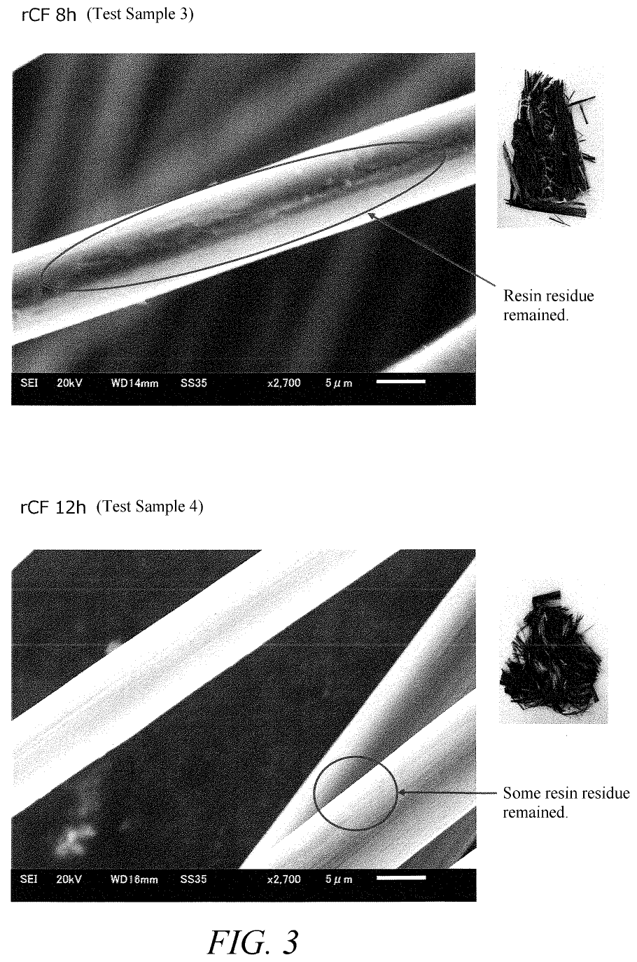

FIG. 4 shows a scanning electron microscope image and photograph of recycled carbon fiber recovered after an automotive carbon fiber reinforced plastics sample is immersed in a nitric acid aqueous solution for 24 hours (Test Example 5), and a scanning electron microscope image and photograph of recycled carbon fiber recovered after an automotive carbon fiber reinforced plastics sample is immersed in a nitric acid aqueous solution for 120 hours (Test Example 6).

FIG. 5 is a graph showing the results of the interfacial shear strength between carbon fibers and plastics in each test example obtained by the microdroplet test.

FIG. 6 is a graph showing the results of the tensile strength of the carbon fibers in each test example obtained by the tensile strength test.

FIG. 7 is a transmission electron microscopic image of a cross section of carbon fibers having a thickness of about 100 nm in Test Examples 1 and 2 produced by focused ion beam processing.

FIG. 8 is a transmission electron microscopic image of a cross section of carbon fibers having a thickness of about 100 nm in Test Examples 4 and 5 produced by focused ion beam processing.

FIG. 9 is a transmission electron microscopic image of a cross section of a carbon fiber having a thickness of about 100 nm in Test Example 6, which was produced by focused ion beam processing.

FIG. 10 is a diagram showing the results of elemental mapping (target elements: C, N, and O) performed by energy dispersive X-ray analysis on a cross section of the carbon fiber of Test Example 1 produced by focused ion beam processing.

FIG. 11 is a diagram showing the results of elemental mapping (target elements: C, N, and O) performed by energy dispersive X-ray analysis on a cross section of the carbon fiber of Test Example 2 produced by focused ion beam processing.

FIG. 12 is a diagram showing the results of elemental mapping (target elements: C, N, and O) performed by energy dispersive X-ray analysis on a cross section of the carbon fiber of Test Example 4 produced by focused ion beam processing.

FIG. 13 is a diagram showing the results of elemental mapping (target elements: C, N, and O) performed by energy dispersive X-ray analysis on a cross section of the carbon fiber of Test Example 5 produced by focused ion beam processing.

FIG. 14 is a diagram showing the results of elemental mapping (target elements: C, N, and O) performed by energy dispersive X-ray analysis on a cross section of the carbon fiber of Test Example 6 produced by focused ion beam processing.

FIG. 15 is a graph showing the peak area ratio of I_{D1}/I_{G1} calculated from the Raman spectrum obtained by Raman spectrometry.

### DESCRIPTION OF EMBODIMENTS

Hereinafter, an embodiment of the modified carbon fiber, a carbon fiber reinforced plastics (CFRP) using the modified carbon fiber, and a method for producing the modified carbon fiber of the present invention will be described in detail.

### <Modified Carbon Fiber>

A modified carbon fiber in accordance with the present embodiment has the proportion of carbon atoms to which a functional group containing at least one of an oxygen atom and a nitrogen atom is bonded is 55.5 atomic % or more and 68.0 atomic % or less, when the total of carbon atoms present on the surface of the carbon fiber and the surface of the internal void inside the carbon fiber is taken as 100 atomic %.

According to the present embodiment, since proportion of carbon atoms to which the above functional group is bonded is within the above range when the total of carbon atoms present on the surface of the carbon fiber and the surface of the internal void inside the carbon fiber is 100 atomic %, the above functional group that can be bonded to matrix resin of CFRP can be present on the surface of the carbon fiber in an appropriate proportion. Accordingly, it is possible to obtain a modified carbon fiber that has superior fiber strength and excellent adhesion to resin than a virgin carbon fiber before impregnated, that is not impregnated, with resin that is to be applied to CFRP parts.

Further, according to the present embodiment, an advantage can be obtained that the modified carbon fiber can be applied to applications that require high performance than applications that a virgin carbon fiber produced with relatively low quality are applied to. Furthermore, according to the present embodiment, an advantage is conduced that a modified carbon fiber applicable to applications requiring high performance can be obtained by recycling the carbon fiber reinforced plastics.

In the carbon fiber, when the total of carbon atoms present on the surface of the carbon fiber and the surface of the internal void inside the carbon fiber is taken as 100 atomic %, if the proportion of carbon atoms to which the above-mentioned functional groups are bonded is less than 55.5 atomic %, a few functional groups involved in adhesion with resin and the adhesion with resin might not be improved. Meanwhile, if the proportion of carbon atoms to which the above-mentioned functional groups are bonded is more than 68.0 atomic %, the effect of improving adhesion with resin is saturated. From the viewpoint of further improving the above-mentioned adhesion, it is more preferable that the proportion of carbon atoms to which the above-mentioned functional groups are bonded is 63.0 atomic % or more and 68.0 atom % or less.

Preferred examples of the above-mentioned functional groups include a carboxyl group, a carbonyl group, a formyl group, an alkoxy group, an ester group, an amino group, a nitro group, a nitroso group, an ammonio group, a cyano group, a sulfo group, and a hydroxyl group. Here, functional groups such as a carboxyl group, a carbonyl group, a formyl group, an alkoxy group, an ester group, an amino group, a nitro group, a nitroso group, an ammonio group, a cyano group, and a hydroxyl group, can be formed to carbon atoms by immersing the carbon fiber reinforced plastics in a nitric acid aqueous solution. The sulfo group can be formed, for example, by immersing the carbon fiber reinforced plastics in a nitric acid aqueous solution containing sulfuric acid.

It is preferable that the modified carbon fiber has a void inside the carbon fiber, and the above-mentioned functional group is present in the void. The presence of the above-mentioned functional groups in the void can reduce the number of stress concentration points when the carbon fiber is subjected tensile load. Therefore, the tensile strength of the modified carbon fiber is further improved that that of the virgin carbon fiber.

The modified carbon fiber preferably has the void at a ratio of 0.1 area % or more and 3.2 area % or less per unit cross-sectional area of the carbon fiber. If the carbon fiber has the void at the above ratio, a graphite structure that constitutes the carbon fiber is scarcely damaged, and a fragile graphite layer existing on the surface of the carbon fiber is removed. This reduces the number of stress concentration points when the modified carbon fiber is subjected to tensile load. Therefore, the tensile strength of the modified carbon fiber can be further improved than that of a virgin carbon fiber including a void at a ratio of more than 3.2 area %. From the viewpoint of further improving the above-mentioned fiber strength thereof, it is more preferable that the carbon fiber has the void at a ratio of 1.0 area % or more and 1.1 area % or less per unit cross-sectional area of the carbon fiber.

Further, in the modified carbon fiber, the intensity ratio (I_{D1}/I_{G1}) of the D1 band of the carbon fiber to the G1 band of the carbon fiber obtained by Raman spectroscopy is preferably 3.4 or less, and 2.1 or more. When the ratio is within the above-mentioned range, there is almost no damage to the crystalline structure of a graphite structure included in the carbon fiber. Therefore, the tensile strength of the modified carbon fiber can be further improved than that of the virgin carbon fiber. From the viewpoint of further improving the above-mentioned fiber strength and adhesion, it is more preferable that the intensity ratio (I_{D1}/I_{G1}) mentioned above is 2.1 or more and 2.3 or less.

### <Carbon Fiber Reinforced Plastics>

The carbon fiber reinforced plastics of the present embodiment is a carbon fiber reinforced plastics produced by reinforcing resin with a modified carbon fiber. The modified carbon fiber has the proportion of carbon atoms to which a functional group containing at least one of an oxygen atom and a nitrogen atom is bonded is 55.5 atomic % or more and 68.0 atomic % or less when the total of carbon atoms present on the surface of the carbon fiber and the surface of the internal void inside the carbon fiber is taken as 100 atomic %.

According to the present embodiment, since the modified carbon fiber in which the proportion of carbon atoms to which the above-mentioned functional groups are bonded is within the above-mentioned range, when the total of carbon atoms present on the surface of the carbon fiber and the surface of the internal void inside the carbon fiber is taken as 100 atomic %, it is possible to obtain a CFRP having better physical properties than a CFRP including a virgin carbon fiber before being impregnated with resin that is to be applied to CFRP parts.

### <Method for Producing Modified Carbon Fiber>

The method for producing a modified carbon fiber according to the present embodiment is a method for producing a modified carbon fiber in which the proportion of carbon atoms to which a functional group containing at least one of an oxygen atom and a nitrogen atom is bonded is 55.5 atomic % or more and 68.0 atomic % or less when the total of carbon atoms present on the surface of the carbon fiber and the surface of the internal void inside the carbon fiber is taken as 100 atomic %. In the method for producing the present embodiment of the modified carbon fiber, a carbon fiber reinforced plastics including a carbon fiber and resin or a carbon fiber is immersed in a nitric acid aqueous solution at a temperature of 60 degree C. or more and 80 degree C. or less and a concentration of 4 mol/L or more and 8 mol/L or less for 8 hours or more, to produce modified carbon fibers. Further, when immersing the carbon fiber reinforced plastics in a nitric acid aqueous solution, the immersion time is preferably 24 hours or less, and more preferably 10 hours or more and 18 hours or less.

According to the present embodiment, compared to the processes described in Patent Document 1 and Patent Document 2, it is possible to obtain at high yield the modified carbon fiber that has excellent fiber strength and excellent adhesion to resin than a virgin carbon fiber a virgin carbon fiber before being impregnated with resin that is to be applied to CFRP parts, under relatively mild and simple processing conditions. Further, according to the present embodiment, an advantage is also obtained that the decomposed resin component can be recovered in a state dissolved in the nitric acid aqueous solution.

If the temperature of the nitric acid aqueous solution is less than 60 degree C. or the concentration is less than 4 mol/L, because the functional groups involved in adhesion to resin is fewer, there is a possibility that the adhesion to the resin is not improved. Further, If the immersion time in the nitric acid aqueous solution is less than 8 hours, because the functional groups involved in adhesion to resin is fewer, there is a possibility that the adhesion to the resin is not improved. Furthermore, if the temperature of the nitric acid aqueous solution exceeds 80 degree C., because the nitric acid aqueous solution boils and evaporates, there is a possibility that the carbon fiber reinforced plastics containing the carbon fiber and resin cannot be immersed in the nitric acid aqueous solution for 8 hours or more. Furthermore, if the concentration of the nitric acid aqueous solution exceeds 8 mol/L, or if the immersion time in the nitric acid aqueous solution exceeds 24 hours, the crystal structure of the graphite structure of the carbon fiber suffers damage. From the viewpoint of obtaining the modified carbon fiber having excellent fiber strength and excellent adhesion to resin with a higher yield, it is preferable that the immersion time be 10 hours or more and 18 hours or less.

### EXAMPLE

Hereinafter, the present invention will be explained in more detail using some test examples, but the present invention is not limited to these test examples.

### (A) Preparation of Sample

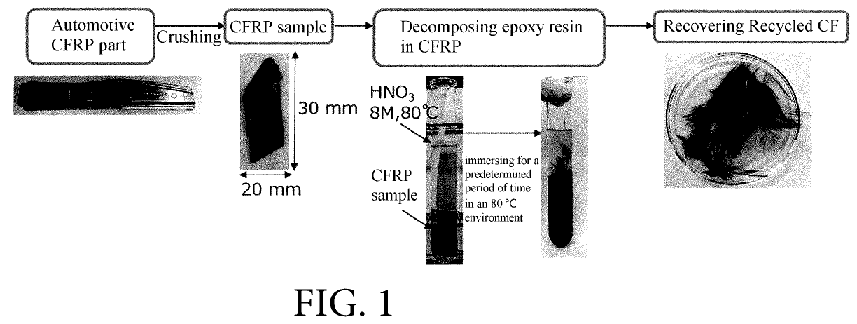

As shown in FIG. 1, a waste product of automotive CFRP parts impregnated with epoxy resin was crushed to obtain a CFRP sample.

### (B) Method for Recovering Recycled Carbon Fiber Using a Nitric Acid Aqueous Solution

The CFRP sample was immersed in a nitric acid aqueous solution adjusted to 8 mol/L in an environment of 80 degree C. for a certain period of time, and then recycled carbon fiber (hereinafter referred to as “rCF”) was obtained.

### (C) Treatment for Virgin Carbon Fiber by a Nitric Acid Aqueous Solution

A virgin carbon fiber to be applied to automobile CFRP parts before being impregnated with resin (hereinafter referred to as “vCF”) was immersed in a nitric acid aqueous solution adjusted to 8 mol/L for a certain period of time in an 80 degree C. environment, and then a vCF immersed in the nitric acid aqueous solution was obtained.

### (D) Observation of the Surfaces of vCF and rCF

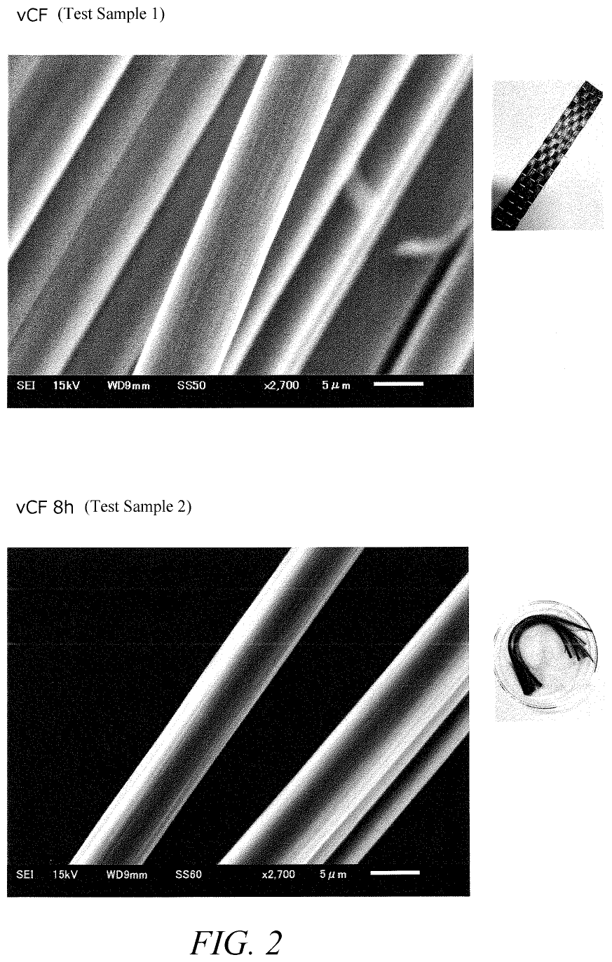

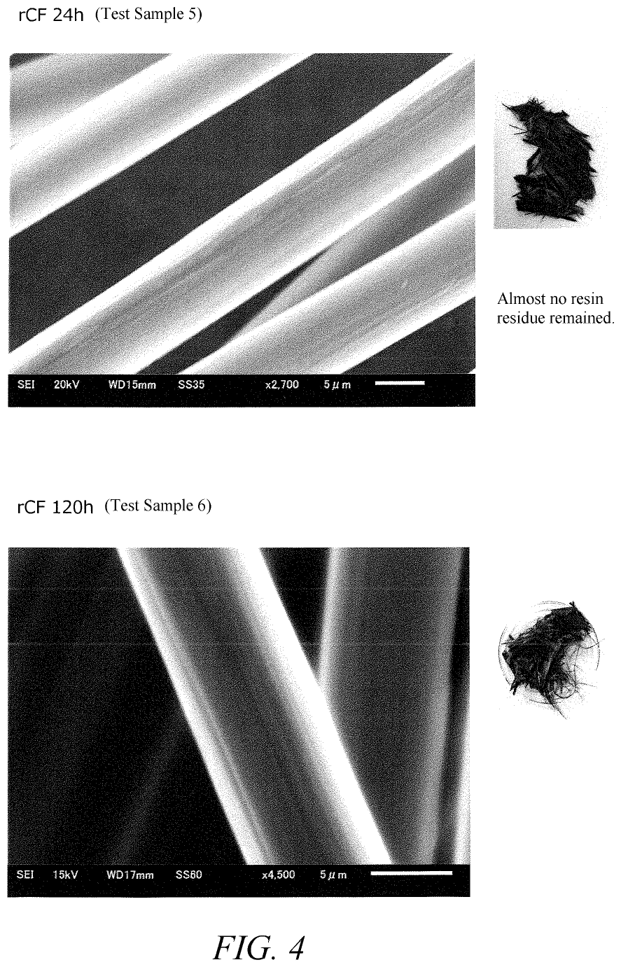

As shown in FIGS. 2 and 4, in a vCF that was recovered after immersing a vCF in a nitric acid aqueous solution for 8 hours (hereinafter referred to as “vCF8h”. The letters after “vCF” will be expressed immersion time.), no damage to the surface was observed due to the immersion of a nitric acid aqueous solution. On the contrary, a clean surface same as vCF was observed. In rCF recovered after 8 hours of immersing the CFRP sample in the nitric acid aqueous solution (hereinafter referred to as “rCF8h”. The letters after “rCF” will be expressed immersion time.), because the immersion time was short, resin did not fully decompose and resin residue remained on the surface was observed. In rCF12h, a small amount of the resin residue was partially observed on the surface. In rCF recovered after sufficiently immersing in the nitric acid aqueous solution (rCF24h, rCF120h), the clean surface with no resin residue was observed.

### (E) Microdroplet Test

### (E-1) Evaluation Method

The adhesion between carbon fiber and epoxy resin was evaluated by performing a microdroplet test on vCF and rCF. The pulling speed of the single fiber in the microdroplet test was set at 0.12 mm/min, the maximum load F (mN) when the resin ball was pulled out was measured, and the interfacial shear strength T (MPa) was calculated using equation (1).

$$τ = F / π d L \times 1 {0}^{3} \qquad ( 1 )$$

Where F is the maximum measured load (mN), d is a carbon fiber diameter (standard value d is 7.0 μm), L is a diameter of a resin ball (measured value is 70 to 90 μm).

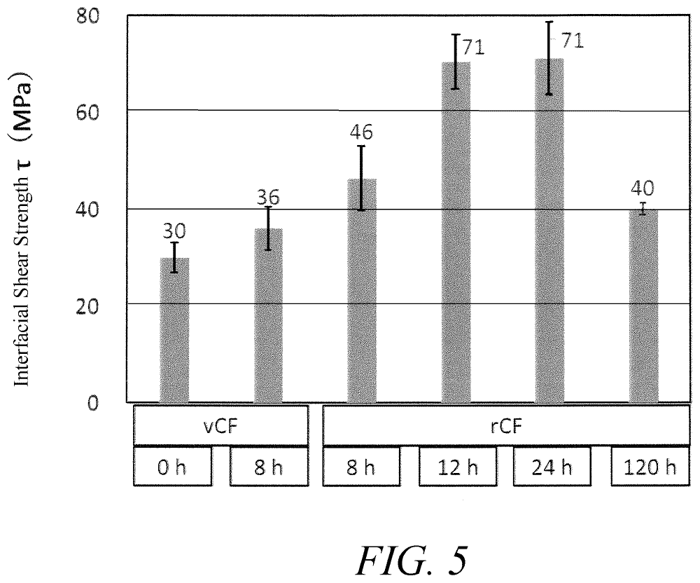

Since it has been reported that the interfacial shear strength T has a positive correlation with the diameter L of the resin ball, the value of T obtained in the measurement is plotted to the diameter L of the resin ball used in the measurement to obtain a linear regression equation. Thereafter, by calculating the interfacial shear strength T corresponding to the resin ball of 70 μm led to the value of the interfacial shear strength for resin balls of the same size. The above result is shown in FIG. 5.

### (E-2) Evaluation Results

Compared to the interfacial shear strength T of vCF is 30±3.1 MPa, the interfacial shear strengths of rCF12h and rCF24h showed significantly higher values. To be specific, the interfacial shear strengths of rCF12h and rCF24h were observed to be 2.2 times higher than the strength of vCF.

### (F) Quantification Test for the Amounts of Functional Groups on the Surface of the Carbon Fiber Using X-Ray Photoelectron Spectroscopy

Usually, the surface of carbon fiber is inert, so the surface thereof with no treatment cannot be bonded with the matrix resin. Therefore, the surface of the virgin carbon fiber be treated to be imparted with a polar functional group that is to be bonded with the resin. From the results shown in E-2 mentioned above, it is presumed that the bonding strength between the carbon fiber and the resin has increased, because during the process of decomposing the epoxy resin with a nitric acid aqueous solution, the functional groups derived from the nitric acid were imparted to the surface of the carbon fiber. Here, the surface of the carbon fiber of each test example was performed to elemental analysis using X-ray photoelectron spectroscopy, and the composition ratios of the functional groups contained in the carbon fiber of each test example are summarized in Table 1. Further, Table 1 shows at the bottoms the total abundance ratio of the functional groups involved in bonding with the resin (C—OH, C—O—C, >C═O, —CO—O—, —NH₂, —NO/NH₄, —NO₂, O) among these functional groups.

TABLE 1

| | | | vCF | rCF | rCF | rCF |
|---|---|---|---|---|---|---|
| | | vCF | 8 h | 12 h | 24 h | 120 h |
| C (atomic %) | CHn | 45.1 | 38.1 | 30.7 | 35.8 | 42.3 |
| | C—OH, | 27.8 | 23.3 | 25.6 | 23.8 | 21.1 |
| | C—O—C | | | | | |
| | >C═O | 2.8 | 3.4 | 4.2 | 3.8 | 3.3 |
| | —CO—O— | 0.8 | 3.0 | 2.6 | 2.7 | 4.0 |
| | —C═C— | 0.7 | 1.9 | 1.4 | 1.5 | 2.0 |
| | Total | 77.2 | 69.7 | 64.5 | 67.5 | 72.7 |
| N (atomic %) | —NH₂ | 0.0 | 1.4 | 1.5 | 1.1 | 1.5 |
| | —NO/NH₄ | 1.2 | 0.7 | 1.3 | 1.3 | 1.3 |
| | —NO₂ | 0.0 | 4.2 | 6.1 | 5.5 | 3.9 |
| | Total | 1.2 | 6.2 | 8.9 | 7.9 | 6.6 |
| O (atomic %) | | 19.5 | 22.6 | 26.8 | 24.5 | 20.5 |
| Others(atomic %) | | 1.9 | 1.6 | 0.1 | 0.0 | 0.2 |

| | | | | | |
|---|---|---|---|---|---|
| The total abundance of the | 52.2 | 58.6 | 68.0 | 62.7 | 55.5 |
| functional groups involved in | | | | | |
| bonding with resin (atomic %) | | | | | |

Table 1 shows that the functional groups involved in bonding with resin are present at 52.2 atomic %, and the total abundances of such functional groups in vCF8h, rCF12h, rCF24h, and rCF120h further increases. A correlation was observed between the total abundance of the functional groups involved in bonding with the resin and the value of the interfacial shear strength with the resin shown in FIG. 5. As above, it was shown that during the process of decomposing the epoxy resin with a nitric acid aqueous solution, the functional groups derived from nitric acid were imparted to the surface of the carbon fiber.

### (G) Tensile Test of Carbon Fiber

### (G-1) Evaluation Method

A tensile test was conducted on each single fiber of vCF and rCF based on JIS R7606. During pulling both ends of the carbon fiber at a tensile speed of 1 mm/min, the maximum load F′ (mN) measured by the testing machine was recorded when the single fiber broke, and the tensile strength a (GPa) was calculated using equation (2).

$$σ = 4 F ’ / π {d}^{2} \qquad ( 2 )$$

Where F′ is maximum load (mN) measured when single fiber broke, d is a carbon fiber diameter (standard value d is 7.0 μm).

### (G-2) Evaluation Results

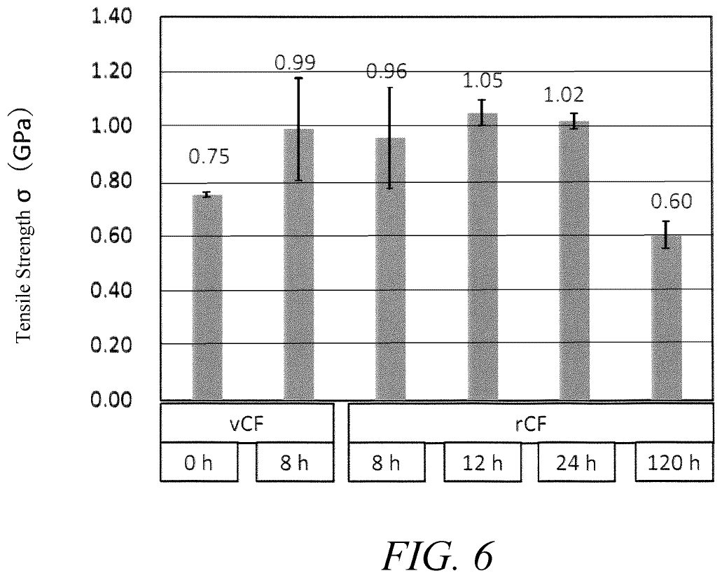

As shown in FIG. 6, the tensile strength a of vCF was 0.75±0.007 GPa, whereas the tensile strength a of rCF24h was 1.02±0.019 GPa. Here, the dispersion of the tensile strength was calculated as the standard deviation value when approximating the Weibull distribution. Similar to the phenomenon that was observed in interfacial shear strength between the fiber and the resin, in recycled carbon fibers recovered after thoroughly immersing in a nitric acid solution (rCF12h and rCF24h), each tensile strength of the single fibers thereof was observed to be improved by 1.4 times than that of vCF.

### (H) Observation of Cross Section of Carbon Fiber

### (H-1) Evaluation Method

In order to observe the cross section of a carbon fiber, a cross section sample with a thickness of about 100 nm was prepared using focused ion beam processing. The prepared cross section sample was observed using a transmission electron microscope, and the element distribution in the cross section was observed using an energy dispersive X-ray spectrometer.

### (H-2) Evaluation Results

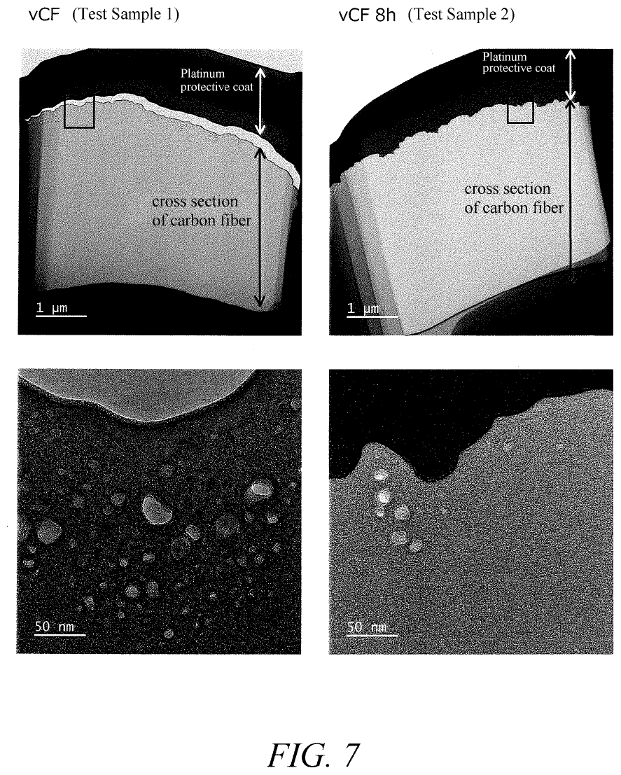

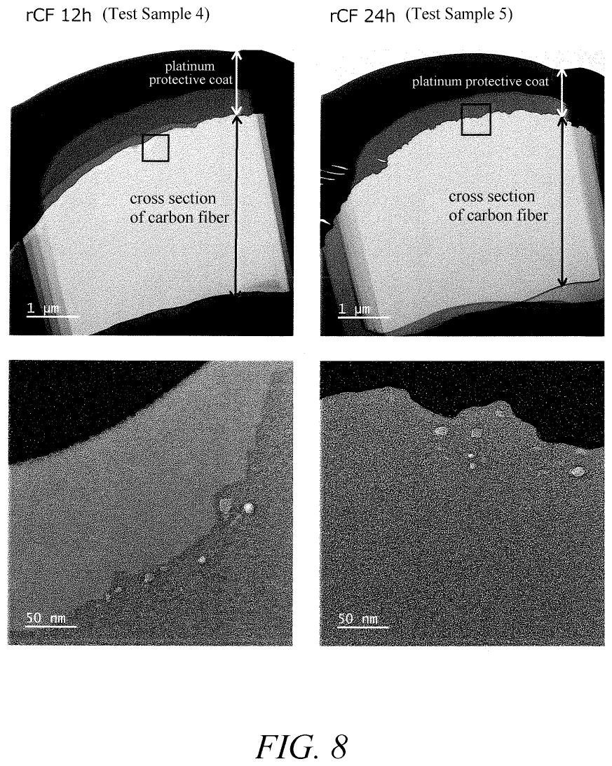

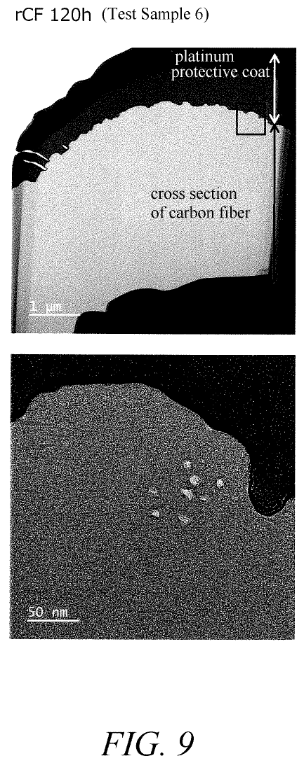

As shown in FIGS. 7 to 9, when the vCF was observed using a transmission electron microscope, a void was found in an internal region 400 nm from the surface of the carbon fiber, and the size of the void is about 1 to 30 nm. Further, when a vCF8h, a rCF12h, a rCF24h, and a rCF120h were observed using a transmission electron microscope, the abundance ratio of the voids was lower than that of the vCF, and the region where the voids existed was 50 nm internal from the surface thereof, which was an extremely close to the surface compared to the vCF. Here, Table 2 shows the results of quantifying the abundance ratio of the voids in any cross section of the observed carbon fibers using an image analysis software of Image J.

TABLE 2

| | Abundance ratio of void (area %) |
|---|---|
| vCF | 3.21 |
| vCF 8 h | 0.95 |
| rCF 12 h | 1.05 |
| rCF 24 h | 1.17 |
| rCF 120 h | 0.23 |

Table 2 shows that in the vCF8h, the rCF12h, the rCF24h, and the rCF120h, each abundance ratio of voids was lower than about ⅓ or less of that of vCF. This is thought to be because surficial graphite structures itself were removed by a nitric acid.

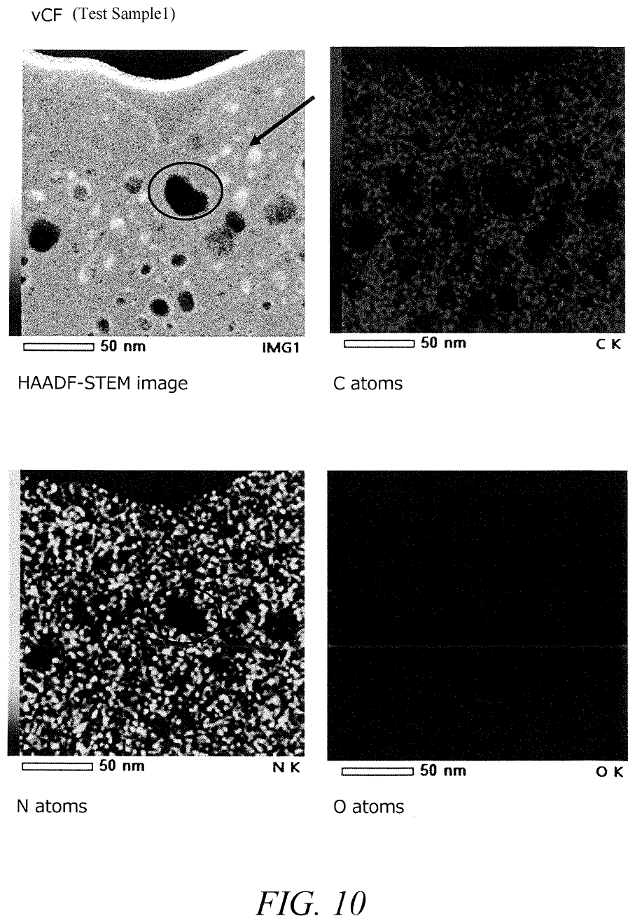

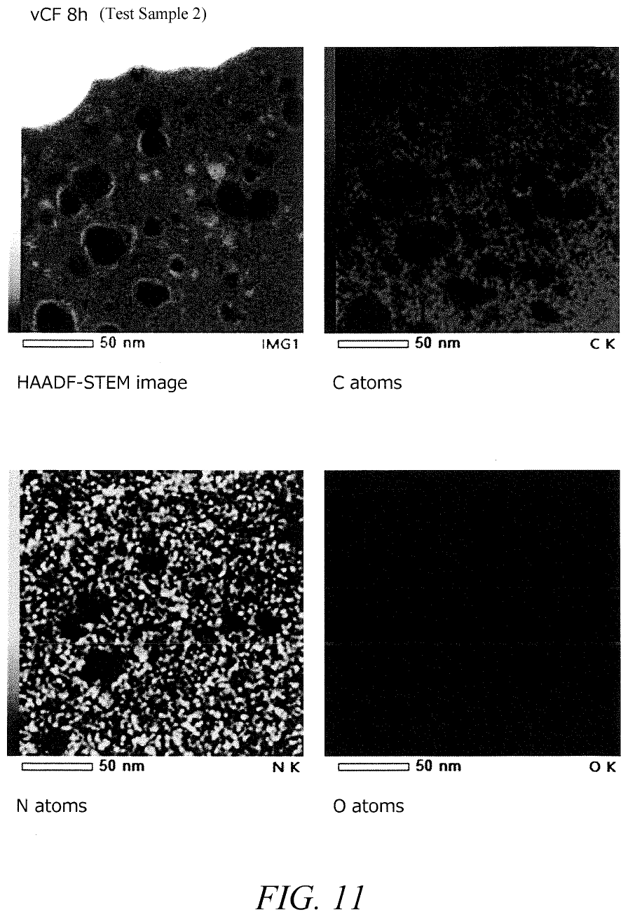

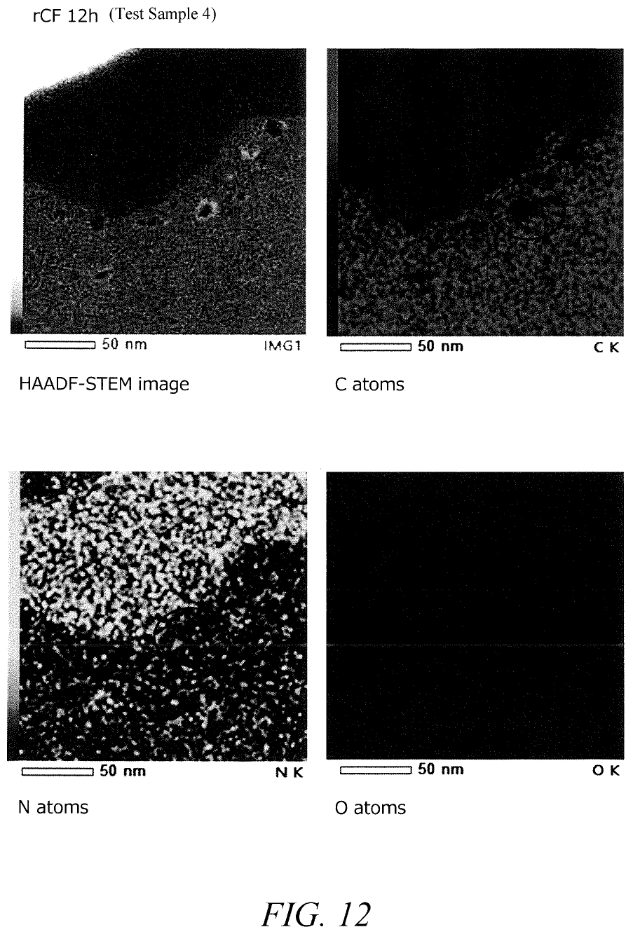

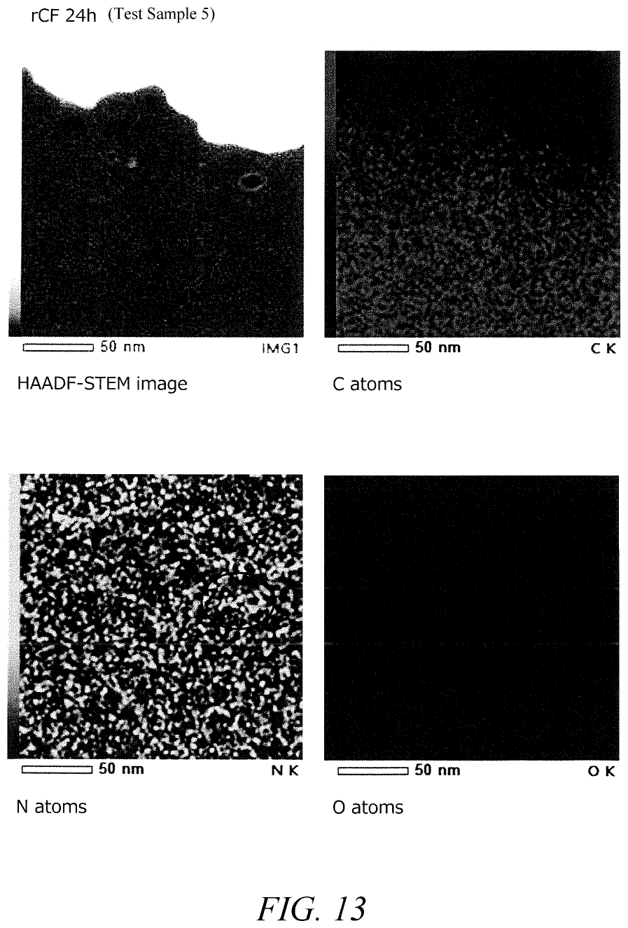

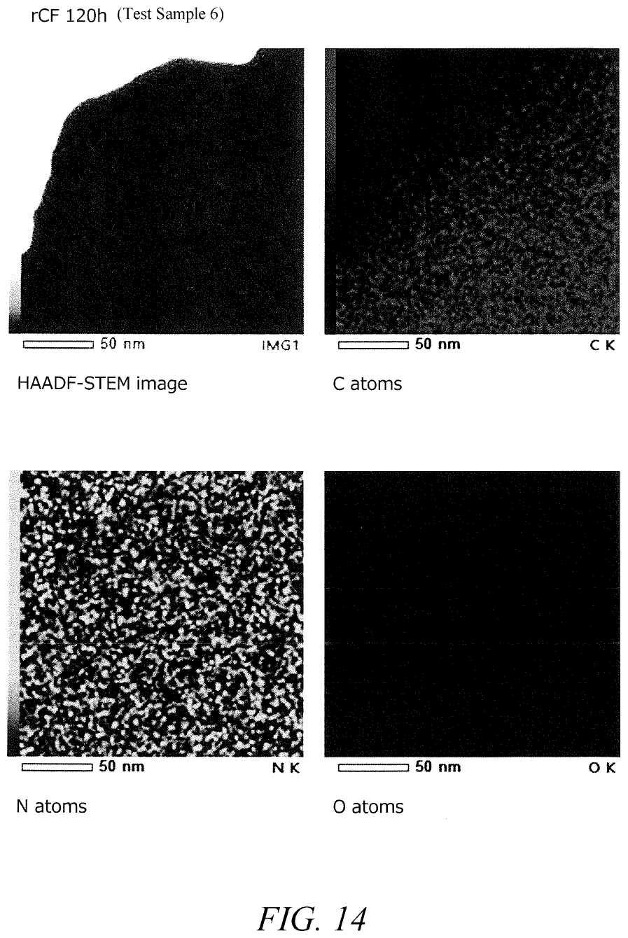

Furthermore, an elemental mapping for C, N, and O of Target elements was performed by an energy dispersive X-ray spectroscopy on the observed void portion. FIGS. 10 to 14 are shown the result obtained from the above. As shown in FIGS. 10 to 14, not only C element but also N and O elements were not found in the void of vCF. Conversely, C element was not found in each void of vCF8h, rCF12h, rCF24h, and rCF120h, similarly to vCF, however, N and O elements were present in each void in high density.

From the above results, the following two factors can be cited as reasons why the tensile strength of a recycled carbon fiber was improved compared to that of a virgin carbon fiber.

The first is that the abundance ratio of voids decreased from in order of vCF8h, rCF12h, rCF24h to rCF120h. It is known that because carbon fiber is a brittle material, and the strength of the carbon fiber is greatly affected by defects on the surface and inside of the carbon fiber. Further, it is known that the smaller the void diameter inside the carbon fiber, the higher the fiber strength. Therefore, it is thought that in fibers with improved tensile strength, the abundance ratio of voids decreased, which reduced the number of stress concentration points when a tensile load was applied, and then improved the tensile strength.

Second, because a functional group containing at least one of the oxygen atom and the nitrogen atom was incorporated into the void, the number of stress concentration points when a tensile load was applied to the carbon fiber was reduced. From the above, this is thought to be because the tensile strength was improved compared to virgin carbon fiber that had not been treated in any way.

### (I) Evaluation of Graphite Structure of Carbon Fiber

### (I-1) Evaluation Method

The areas of the G1 peak and D1 peak were calculated from the Raman spectrum obtained from Raman spectrometry. The G1 peak represents a peak derived from a six-membered carbon ring structure (high crystallinity), and the D1 peak represents a peak derived from structural disorder (low crystallinity) such as partial cleavage of the six-membered carbon ring. From the above, the graphite structure was evaluated based on the peak area ratio of D1/G1. The above result is shown in FIG. 5.

### (I-2) Evaluation Results

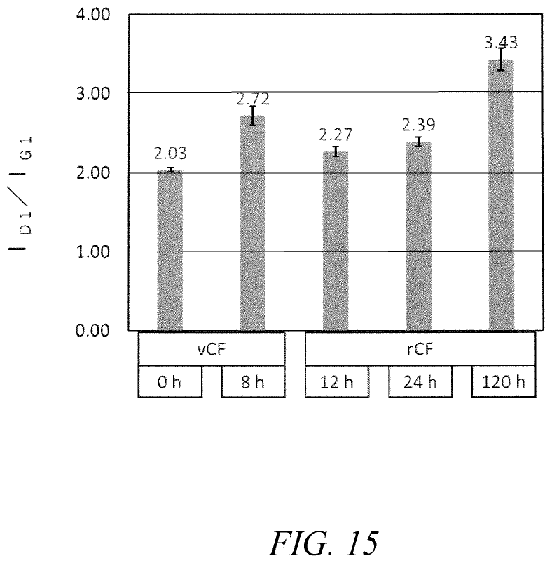

As shown in FIG. 15, the peak area ratios of rCF12h and rCF24h are not much different from that of vCF. Meanwhile, the peak area ratio of vCF8h was shown 1.3 times higher than that of vCF, and the peak area ratio of rCF120h was shown 1.7 times higher than that of vCF. From the above results, it was shown that on the surface of rCF120h, the graphite structure was disturbed, and the crystallinity was decreased. Here, from the results shown in FIG. 6, it was observed that the tensile strength of rCF120h was gradually decreased. This is thought to be due to damage such as disturbance or loss of the graphite structure of carbon fiber resulting from being immersed in a nitric acid aqueous solution for a long time.

From FIGS. 5 and 6, it can be seen that Test Examples 2 to 6, which fall within the scope of the present invention, have excellent the fiber strength and the excellent adhesion to resin. Moreover, from FIG. 5, FIG. 6, and FIG. 15, it seems that Test Example 4 and Test Example 5, in particular Test Example 4, give the best results from the viewpoint of the fiber strength and the adhesion.

While the present invention has been described with some embodiments and test examples, the present invention is not intended to be limited thereto, and various modifications can be made within the gist of the present invention.

In the present invention, in order to provide a modified carbon fiber having the excellent fiber strength and excellent adhesion to resin, carbon fiber reinforced plastics including the modified carbon fiber, and a method for producing the modified carbon fiber, the main point is that the carbon fiber includes on the surface thereof the above-mentioned functional groups in the above-mentioned proportions.

Furthermore, for example, the above-mentioned components are not limited to the configurations shown in each embodiment or each test example, and details of the specifications and materials of virgin carbon fiber and resin may be changed. Or, it is also possible to apply the components of an embodiment in combination with the components of other embodiments.

1. A modified carbon fiber including carbon atoms in which a proportion of carbon atoms to which a functional group containing at least one of an oxygen atom and a nitrogen atom is bonded are 55.5 atomic % or more and 68.0 atomic % or less, when a total of carbon atoms present on a surface of the carbon fiber and a surface of an internal void inside the carbon fiber is 100 atomic %.

2. The modified carbon fiber according to claim 1,
wherein the functional group is at least one selected from the group consisting of a carboxyl group, a carbonyl group, a formyl group, an alkoxy group, an ester group, an amino group, a nitro group, a nitroso group, an ammonio group, a cyano group, a sulfo group, and a hydroxyl group.

3. The modified carbon fiber according to claim 1,
wherein the carbon fiber includes the internal void which is present in a proportion of 0.1 area % or more and 3.2 area % or less per a unit cross-sectional area of the carbon fiber.

4. The modified carbon fiber according to claim 3,
wherein the functional group containing at least one of the oxygen atom and the nitrogen atom is present in the void.

5. The modified carbon fiber according to claim 3,
wherein an intensity ratio (I_{D1}/I_{G1}) of a D1 band of the carbon fiber to a G1 band of the carbon fiber obtained by Raman spectroscopy is preferably 3.4 or less.

6. A carbon fiber reinforced plastics in which resin is reinforced with a modified carbon fiber, wherein the modified carbon fiber includes carbon atoms, and
a proportion of the carbon atoms to which a functional group containing at least one of an oxygen atom and a nitrogen atom is bonded is 55.5 atomic % or more and 68.0 atomic % or less, when a total of the carbon atoms present on a surface of the carbon fiber and a surface of an internal void inside the carbon fiber is 100 atomic %.

7. A method for producing a modified carbon fiber in which the proportion of the carbon atoms to which a functional group containing at least one of the oxygen atom and the nitrogen atom is bonded is 55.5 atomic % or more and 68.0 atomic % or less, when a total of carbon atoms present on a surface of the carbon fiber and a surface of an internal void inside the carbon fiber is 100 atomic %,
comprising immersing carbon fiber reinforced plastics including a carbon fiber and resin, or a carbon fiber in a nitric acid aqueous solution at a temperature of 60 degree C. or more and 80 degree C. or less, a concentration of 4 mol/L or more and 8 mol/L or less, and for 8 hours or more.
